(19) United States
(12) Patent Application Publication
(10) Pub. No.: US 2020/0102985 A1
(43) Pub. Date: Apr. 2, 2020

(54) OIL JET IN A CONFINED AXIAL SPACE

(71) Applicant: Rolls-Royce Corporation, Indianapolis, IN (US)

(72) Inventors: Kerry Lighty, Plainfield, IN (US); David Farnum, Indianapolis, IN (US)

(73) Assignee: Rolls-Royce Corporation, Indianapolis, IN (US)

(21) Appl. No.: 16/146,660

(22) Filed: Sep. 28, 2018

(51) Int. Cl. F16C 33/66; F01D 25/18

(52) U.S. Cl. CPC F16C 33/6677; F16C 33/6681; F16C 2360/23; F01D 25/18; F16C 33/667; F16C 33/6651

(57) ABSTRACT

A system and method for directing a fluid in a rotating machine is provided. The system may comprise a shaft, a fluid catching member, and a fluid jet. The fluid catching member may be positioned radially outward of the shaft. The fluid catching member may have a surface and a flange. The surface may extend radially outward from the shaft. The flange may extend radially along a portion of the shaft and way from the surface. The flange may bound, in part, a fluid catchment volume between the flange and a portion of the shaft. The fluid jet may be positioned radially outward of the fluid catching member flange. The fluid jet may be configured to eject a stream of fluid under pressure such that the stream of fluid has low angle of incidence with the surface of the fluid catching member at the first point where the stream contacts the surface.

### CROSS-REFERENCE TO RELATED APPLICATIONS

This application is related to concurrently filed U.S. patent application No. XXXXX entitled “SYSTEMS AND METHODS OF OIL DISTRIBUTION FOR A BEARING,” Docket Number G2640-00236/RCA12168, filed Sep. 28, 2018, inventors: Kerry Lighty, Andrew Schwendenmann and Eric McClellan; U.S. patent application No. XXXXX entitled “SPLINED OIL CATCHER,” Docket Number G2640-00238/RCA12169, filed Sep. 28, 2018, inventors: Kerry Lighty and Brian Fish; and U.S. patent application No. XXXXX entitled “DRAIN ARRANGEMENT FOR A SQUEEZE FILM DAMPER,” Docket Number G2640-00242/RCA12171, filed Sep. 28, 2018, inventors: Kerry Lighty, David Farnum, Daniel Feinstein and Joseph Swift. The entirety of these applications are herein incorporated by reference.

### BACKGROUND

In machines containing a rotating shaft, the shaft is typically mounted to a support structure by one or more bearings. The bearings facilitate the relative motion (rotation) between the shaft and the support structure while maintaining the relative positioning between the two components. These bearings often require a fluid, e.g., oil, to remove heat from and/or lubricate the bearings.

### SUMMARY

According to some aspects of the present disclosure, a system for directing a fluid to a bearing in a machine have a rotating shaft is provided. The system may comprise a rotatable shaft, a support structure, one or more bearings, a fluid catching member, and a fluid jet. The shaft may define the axis of the machine. The one or more bearings may be positioned about the circumference of the shaft and may support and align the shaft to the support structure. The fluid catching member may be positioned radially outward of the shaft. The fluid catching member may have a surface and a flange. The surface may extend radially outward from said shaft and define one or more fluid supply orifices. The flange may extend axially along a portion of the shaft and bound, in part, a fluid catchment volume between the flange a portion of a surface of the shaft that is in axial alignment with the flange. The fluid jet may be positioned radially outward of the fluid catching member and may be configured to eject a stream of fluid under pressure. The stream may have an impingement area on the shaft at least partially within the fluid catchment volume to thereby provide the fluid to the one or more supply orifices. The fluid jet may be configured to eject the stream such that at least a portion of the stream impinges the shaft at a low angle of incidence.

According to some aspects of the present disclosure, a system for directing a fluid in a rotating machine is provided. The system may comprise a shaft, a fluid catching member, and a fluid jet. The shaft may define the axis of the machine. The fluid catching member may be positioned radially outward of the shaft. The fluid catching member may have a surface and a flange. The surface may extend radially outward from the shaft. The flange may extend axially along a portion of the shaft and way from the surface. The flange may bound, in part, a fluid catchment volume between the flange and a portion of the shaft. The fluid jet may be positioned radially outward of the fluid catching member flange. The flange may be configured to eject a stream of fluid under pressure such that the stream of fluid has a low angle of incidence with the surface of the fluid catching member at the first point where the stream contacts the surface.

According to some aspects of the present disclosure, a method of supplying a fluid in a rotating machine is provided. The machine may comprise a shaft that defines an axis, a fluid catching member, and a fluid jet. The fluid catching member may be affixed to and have a surface extending radially outward from the shaft. The fluid jet may be located radially outward from the fluid catching member. The method may comprise ejecting a stream of fluid from the fluid jet in a direction substantially parallel to the surface of the fluid catching member.

### BRIEF DESCRIPTION OF THE DRAWINGS

The following will be apparent from elements of the figures, which are provided for illustrative purposes.

FIGS. 1A and 1B are axial cutaway views of a system for directing a fluid in a rotating machine in accordance with some embodiments of the present disclosure.

FIG. 2 is perspective view of the system of FIGS. 1A and 1B in accordance with some embodiments of the present disclosure.

FIG. 3 is a perspective view of a system for directing a fluid in a rotating machine in accordance with some embodiments of the present disclosure.

FIG. 4 is an axial cutaway view of a system for directing a fluid in a rotating machine in accordance with some embodiments of the present disclosure.

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclosure. The claims are intended to cover implementations with such modifications.

### DETAILED DESCRIPTION

For the purposes of promoting an understanding of the principles of the disclosure, reference will now be made to a number of illustrative embodiments in the drawings and specific language will be used to describe the same.

A turbine engine is an example of a machine having a rotating shaft. Often the shafts of a turbine engine are mounted to a static support structure, such as the casing, using bearings. During operation of the turbine engine, the temperature of the bearing may rise due to friction between the rolling contact surfaces. This friction generates heat. To prevent excessive bearing temperatures, heat must be removed from the bearings during operation. This heat may be removed by the use of a fluid, e.g., oil, that is supplied to and flows over the bearing surfaces. The fluid may also function to lubricate the bearing rolling contact surfaces. Heat from the bearing is transferred into the fluid because the fluid is at a lower temperature than the bearing. After removing heat from the bearing, the fluid is passed through a structure, e.g., a heat exchanger, that transfers heat from the fluid to the environment, either directly or indirectly.

The present disclosure is directed to a system for supplying a fluid to a structure, e.g., a bearing, of a machine having a rotatable shaft. Some machines having a rotatable shaft, e.g., a turbine engine, often contain a myriad of other components and design parameters to consider when determining how to direct the flow of fluids within the machine. Additionally, the relative movement between the shaft (or components attached thereto) and the support structure provides challenges to the design of these systems. As disclosed herein, a system for directing fluid to a supporting structure in a machine having a small, axially compressed annual space that overcomes the aforementioned challenges is provided.

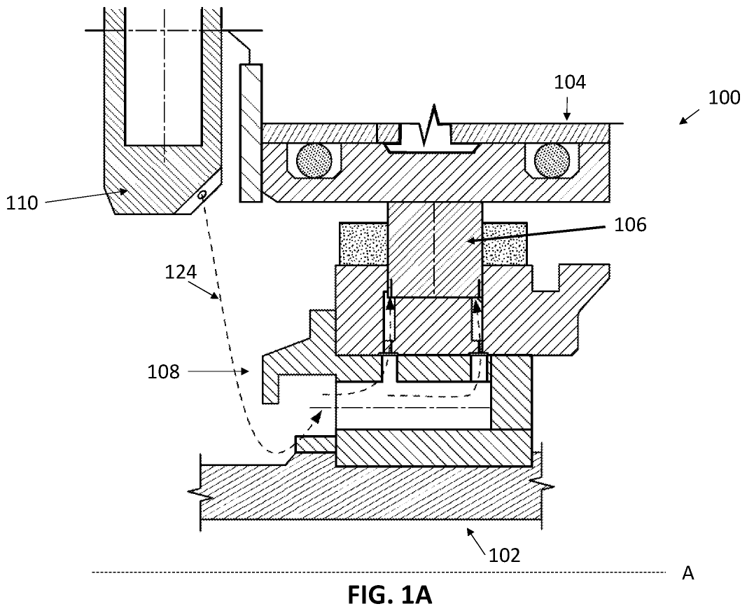

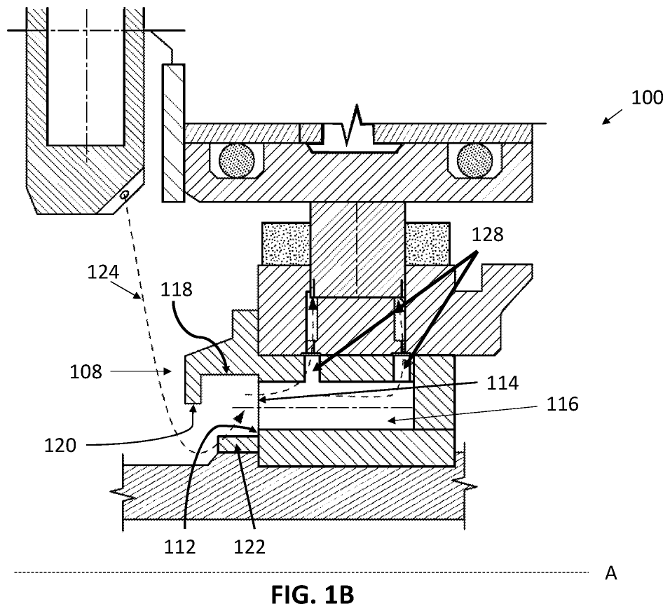

In accordance with some embodiments of the present disclosure, a system 100 for supplying a fluid to a structure within a rotatable machine is provided in FIGS. 1A and 1B. The system 100 may comprise a shaft 102, a support structure 104, one or more bearings 106, a fluid catching member 108, and fluid jet 110.

The shaft 102 defines the axis ‘A’ of the machine by the axis about which shaft 102 rotates.

The forward and aft ends of the machine are typically defined in relation to the vehicle, e.g., aircraft, in which they are contained. In some embodiments, the left side of FIG. 1A is the forward end of the machine; the right side of FIG. 1A is the aft end of the machine. The axis about which the shaft 102 rotates also defines the radial and circumferential directions of the machine. The radial direction is perpendicular to the axis and either points directly away from, or directly toward, the axis. The circumferential direction is defined as being perpendicular to both the axial and radial directions. In FIG. 1A, components that are shown nearer the top of the page, e.g., fluid jet 110, are located radially outward of components nearer the bottom of the page, e.g., shaft 102.

In accordance with some embodiments, shaft 102 is supported to and aligned with the support structure 104 by one or more bearings 106. The bearings 106 may be located around the circumference of the shaft 102. The temperature of these bearings 106 will increase as the machine is operated. In order to prevent excessive temperatures that could damage the bearing and endanger the safe operation of the machine, a fluid is supplied to the fluid catching member 108 by fluid jet 110 to remove heat from bearings 106. In some embodiments, the fluid further also lubricates the bearings 106.

With reference to FIG. 1B, additional components of the fluid catching member 108 are illustrated in accordance with some embodiments of the present disclosure. Fluid catching member 108 may be positioned radially outward of the shaft 102. Fluid catching member 108 may be affixed to shaft 102 by press fitting or other equivalent means such that the fluid catching member 108 rotates with shaft 102. Fluid catching member 108 may comprise a surface 112. Surface 112 extends radially outward from the shaft 102. Surface 112 may further comprise and define one or more fluid supply orifices 114. The fluid supply orifices 114 comprise the opening of axial hole 116. Axial hole 116 is configured to receive a supply of fluid and direct it axially to radial supply holes 128 that directly supply bearing 106 with the fluid. In some embodiments, surface 112 may comprise one or more orifices 114, each supplying a separate axial hole 116.

Fluid catching member 108 may further comprise flange 118. As shown in FIG. 1B, flange 118 may extend axially from surface 112 along a portion of the shaft 102. During operation, flange 118 functions to prevent the outward radial movement of the fluid that would otherwise occur due to the spinning of shaft 102. Fluid catching member 108 may further comprise retention member 120. The retention member may also be referred to as retention lip 120. Retention lip 120 may extend radially inward from flange 118 at a forward axial end of flange 118. The retention lip 120, flange 118, and surface 112 define an annular groove in the fluid catching member 108. This annular groove helps collect and retain fluid. By sizing and positioning the radial extension of the retention lip 120 in relation to fluid supply orifice 114 defined by surface 112, a proper amount of fluid can be supplied to the axial hole 116 prior to the fluid spilling over the retention lip 120.

In accordance with some embodiments, the fluid catching member 108 may further comprise a deflecting member 122. In some embodiments, the deflecting member 122 may be integral with shaft 102. In some embodiments, the deflecting member 122 may be a component separate from both the fluid catching member 108 and the shaft 102. Deflecting member 122 may comprise a fillet. The deflecting member may comprise a first and second end (which may be a forward and aft axial end), and an outer surface located radially outward from and facing away from shaft 102. The outer surface of the deflecting member 122 at the aft axial end may be located radially outward of the outer surface of the deflecting member 122 at the forward axial end. The difference in radial positioning of the outer surface at both ends creates a ramp that facilities supplying the fluid from the fluid jet 110 to the fluid catching member 108 and, more particularly, to the fluid supply orifice 114 defined by the surface 112.

Fluid catching member 108 and shaft 102 may define a fluid catchment volume by bounding the same. More particularly, one or more of the flange 118, retention lip 120, surface 112, deflecting member 122, and shaft 102 may bound the fluid catchment volume into which fluid jet 110 supplies fluid and in which the system fluid supplied to bearings 106 may be retained.

The system fluid may be supplied to the fluid catching member 108 by fluid jet 110. As shown in FIG. 1A, the fluid jet 110 may be positioned radially outward of fluid catching member 108 and, in particular, flange 118 of fluid catching member 108. Additionally, fluid jet 110 may be located axially forward of surface 112. In some embodiments, the most axially forward portion of the fluid catching member 108 and, in particular, flange 118 and retention lip 120 may be located axially aft of the fluid jet 110.

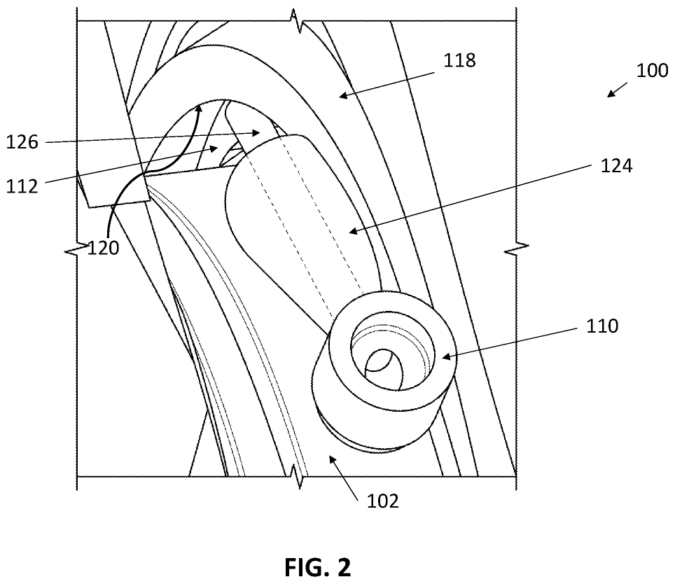

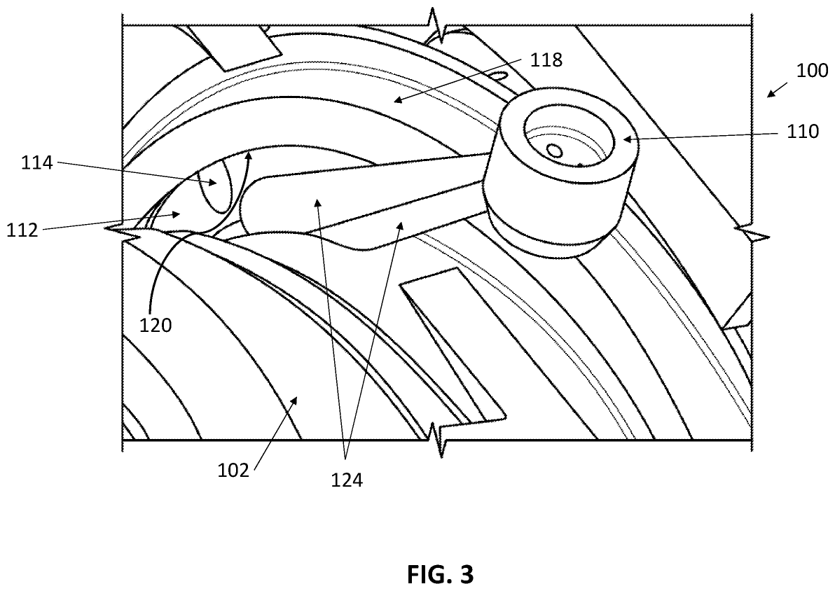

Fluid jet 110 is configured to eject a stream 124 of fluid under pressure into the fluid catchment volume. Being a cutaway view of the system 100 along the axis of the machine, only the radial and axial components of the velocity of stream 124 are shown in FIGS. 1A and 1B—the circumferential component of the velocity of stream 124 is seen in FIGS. 2 and 3. As can be seen in FIGS. 1A and 1B, the stream 124 moves radially inward toward the shaft 102 and aft along the axis of the machine. Stream 124 may be directed in the direction of the rotation of shaft 102. Directing stream 124 in the direction of rotation of shaft 102 aids in the amount of oil deflected off the surface of the shaft 102 toward the fluid catching member 108 when the stream 124 impinges the shaft 102. As the stream 124 impinges shaft 102, the inward radial component of the stream 124 velocity is arrested. The axial and circumferential components of the stream 124 velocity remains and the fluid flows toward the surface 112 of the fluid catching member 108.

In some embodiments, stream 124 does not directly impinge the shaft 102. Rather a surface, such as that provided by deflecting member 122, is attached the fluid catching member 108 and overlays a portion of the shaft 102. Stream 124 is then directed to impinge on the surface of the deflecting member 122 rather than the shaft 102. In other embodiments, the stream 124 may impinge on a portion of both the shaft 102 and the fluid catching member 108 surface, such as that provided by the deflecting member 122. In some embodiments, the deflecting member 122 may be integrated with the shaft 102, or, in other embodiments, it may be provided as a component separate from both the shaft 102 and the fluid catching member 108.

Stream 124 also comprises a component of velocity in the circumferential direction when it is ejected from the fluid jet 110. This component is best illustrated in FIGS. 2 and 3. Ejecting the stream 124 in this manner allows for a lower angle of incidence at the point where the stream 124 impacts surface 112 of fluid catching member 108. This lower angle of incidence can be achieved because of the substantial component of the stream 124 velocity is parallel to surface 112.

In many art solutions, a fluid stream 124 would contact surface 112 in a direction that is substantially normal to surface 112. Many of those systems were able to accommodate a more axially-directed stream 124 because they were not as axially compressed.

FIG. 2 illustrates this lower angle of incidence. Targeting direction 126 represents the location on the surface 112 to which the stream 124 is directed by the fluid jet 110. The angle of incidence between this direction 126 and the surface 112 is much lower than the substantially perpendicular angles seen in some prior art systems. In some embodiments, the angle of incidence between the stream 124 and surface 112 as measured at their first point of contact, is less than 30 degrees. In some embodiment the angle of incidence is less than 15 degrees. In some embodiments, the angle of incidence is approximately 10 degrees.

A lower angle of incidence is also achievable between a portion of the stream 124 of fluid and the shaft 102 at the point (or points) of contact when compared to prior art systems. In some embodiments, the angle of incidence between any portion of stream 124 impinging on shaft 102 does not exceed 45 degrees. In some embodiments, the angle of incidence between any portion of stream 124 impinging on shaft 102 does not exceed 30 degrees. In some embodiments, the angle of incidence between any portion of stream 124 impinging on shaft 102 is between 15 and 30 degrees. In some embodiments, the angle of incidence between any portion of stream 124 impinging on shaft 102 is between 10 and 20 degrees. In some embodiments, the angle of incidence between any portion of stream 124 impinging on shaft 102 does not exceed 10 degrees.

FIGS. 2 and 3 further illustrate that the fluid jet 110 is circumferentially displaced from the portion of the fluid catchment volume into which it directs stream 124. It should be understood that the fluid catching member 108, being affixed to the shaft 102, rotates about the circumference of the machine. However, there is a generally fixed, relative to the static components of the machine, volume that all or a portion of fluid catchment volume occupies when it receives the stream 124 from fluid jet 110.

The orientation of stream 124 as ejected from fluid jet 110 enables the stream 124 to be ejected more directly into the fluid catchment volume defined by the fluid catching member 108 and shaft 102 than prior art systems. In some embodiments, a portion of stream 124 may be directed not just into the fluid catchment volume, but into the annular groove defined by the retention lip 120, flange 118, and surface 112 of fluid catching member 108. Retention lip 120 maintains the fluid in the annular groove until a sufficient supply of fluid is provided to orifice 114. If the amount of fluid supplied to the annular groove exceeds the capacity of the orifice 114, the fluid will eventually spill over the retention lip 120.

In some embodiments, the stream 124 may be directed toward the fluid supply orifice 114. A portion of the stream 124 may be provided to the orifice 114 without impinging the shaft 102, surface 112, deflecting member 122, flange 118 and/or retention lip 120.

In some embodiments, the fluid jet 110 may be configured to eject the stream 124 of fluid such that said stream 124 impinges on an area of shaft 102. The stream 124 of fluid that impinges on the impingement area of the shaft may, when impinging be at least partially within the fluid catchment volume.

In accordance with some embodiments, the fluid jet 110 defines a nozzle that directs the stream of fluid 124. The nozzle may have a length, measured in the direction in which the stream 124 is ejected, and a diameter, measured in a direction perpendicular to the nozzle length. These parameters form a ratio known as L/D. In some embodiments, the L/D of the nozzle of fluid jet 110 is greater than 2.5. In some embodiments, the L/D of the nozzle of fluid jet 110 between 4 and 5. In some embodiments, the L/D of the nozzle of fluid jet 110 is 4.8.

In accordance with some embodiments, a fluid jet 110 that provides two streams 124 of fluid is provided. A second nozzle may be provided to allow for a sufficient amount of fluid flowing to bearing 106. Using two nozzles, each forming a narrower stream of fluid than embodiments that employ a single nozzle, helps to improve the capture efficiency of the fluid catching member 108.

In accordance with some embodiments of the present disclosure, a method of supplying a fluid in a rotating machine is provided. The rotating machine may comprise the components are described above for system 100. The method may comprise ejecting a stream 124 of fluid from said fluid jet 110 in a direction that is substantially parallel to surface 112 of fluid catching member 108. Substantially parallel means that the component of velocity of stream 124 in a direction parallel to the surface 112 (i.e., circumferentially at the point of ejection from fluid jet 110) is greater than the component of velocity of stream 124 in either the radial or axial directions. In some embodiments, the component of velocity in the radial and circumferential directions are approximately equal and many times to an order of magnitude larger than the component of velocity in the axial direction. The method may further comprise impinging the shaft 102 with the stream 124 of fluid prior to said stream 124 contacting said surface 112. The stream 124 may contact the shaft 102, surface 112, or both with the angle of incidences as described above.

The embodiments described above with respect to FIGS. 1A to 3 direct the system fluid from fluid jet 110 to fluid catching member 108 that supplies fluids to a bearing 106 from underneath the bearing 106 via axial hole 116 and radial holes 128 on both sides of bearing 106—also known as “under race lubrication.” Supplying the fluid from the underside of bearing is a particularly effective means of cooling and lubricating bearings in high speed applications. The fluid catchment volume defined between the fluid catching member 108 and shaft 102, and the particular orientation of the stream 124 provided by fluid jet 110 are both crucial to enabling effective under race lubrication in high speed, axially compressed designs.

In lower speed applications, fluid can be delivered directly to a bearing rather than via the fluid catching member as described. Direct delivery of the fluid to the bearing is possible because the fluid is able to penetrate between the rolling elements of the bearing at lower speeds. While direct application is possible, some of the fluid supplied directly to the bearing will still “splash” away from the rotating surfaces and not lubricate and cool the bearing.

A benefit of the low angle of incidence stream 124, described above, is a reduction in the amount of the fluid that splashes when the stream 124 contacts a rotating element. Consequently, the application of a fluid jet 110 that directs a stream 124 in the orientations described above directly onto a bearing 106 can improve system performance in lower speed applications as well as high speed applications.

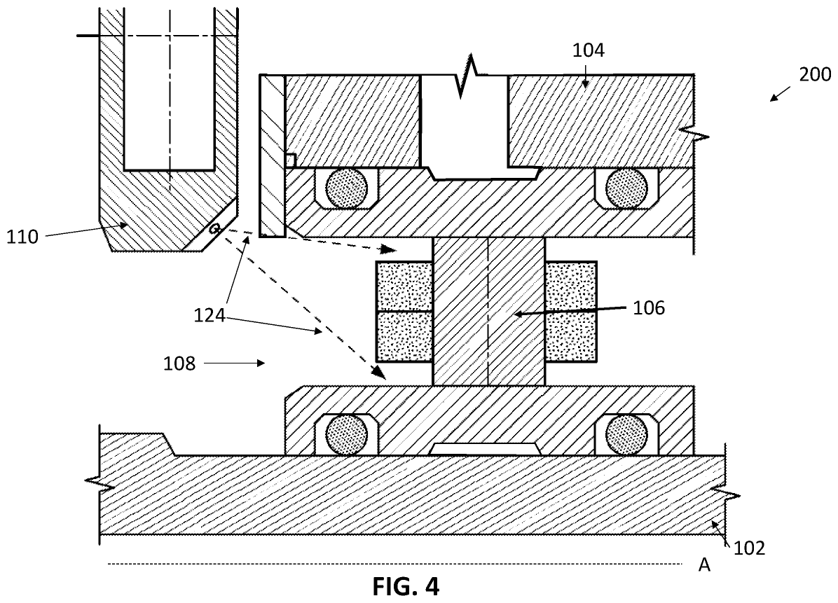

In accordance with some embodiments of the present disclosure, a system 200 for directly supplying a fluid to a bearing is provided in FIG. 4. System 200 comprises many of the same components performing the same functions as described above in relation to system 100. Notably, system 200 does not contain fluid catching member 108 because the lower rotational speed of system 200 allows the fluid to be directly supplied to bearing 106. Additionally, fluid stream 124 can be supplied to either the top, bottom, or both sides of the bearing by targeting stream 124 between the bearing cage and either the inner or outer bearing ring.

Similar to stream 124 described above in relation to system 100, it should be understood that stream 124 in FIG. 4 contains a substantial component of velocity that is parallel to an axially-forwarding facing surface of the bearing 106 such that the stream 124 contacts this surface at the low-angle of incidences as described above in relation to surface 112.

Although examples are illustrated and described herein, embodiments are nevertheless not limited to the details shown, since various modifications and structural changes may be made therein by those of ordinary skill within the scope and range of equivalents of the claims.

What is claimed is:

1. A system for directing fluid to a bearing supporting a rotatable shaft in a machine comprising:
a rotatable shaft defining an axis of the machine;
a support structure;
one or more bearings positioned about the circumference of said shaft for supporting and aligning said shaft to said support structure;
a fluid catching member positioned radially outward of said shaft, said fluid catching member having:
a surface extending radially outward from said shaft, said surface defining one or more fluid supply orifices; and
a flange extending axially along a portion of said shaft, said flange bounding in part a fluid catchment volume between said flange and a portion of a surface of said shaft in axial alignment with said flange; and
a fluid jet positioned radially outward of said fluid catching member flange and being configured to eject a stream of fluid under pressure having an impingement area on said shaft at least partially within said fluid catchment volume to thereby provide said fluid to said one or more supply orifices,
wherein said fluid jet is configured to eject said stream such that at least a portion of said stream impinges said shaft at an angle less than 45 degrees.

2. The system of claim 1, wherein said fluid jet is configured to eject said stream such that at least a portion of said stream impinges said shaft at an angle less than 30 degrees.

3. The system of claim 1, wherein said fluid jet has a length, in the direction of the ejected stream of fluid, and a diameter that is perpendicular to the direction of the ejected stream of fluid, wherein said length is at least 2.5 times greater than said diameter.

4. The system of claim 3, wherein said length is 4.8 times greater than said diameter.

5. The system of claim 1, wherein said fluid catching member further comprises a retention member extending radially inward from said axially extending flange.

6. The system of claim 1, wherein said fluid catching member comprises a deflecting member having an outer surface, said outer surface having a forward axial end and an aft axial end, wherein said outer surface at said aft axial end is radially outward of said outer surface at said forward axial end.

7. The system of claim 1, wherein an angle between said surface of said catching member and a centerline of said stream of fluid measured at a first point where the stream contacts said surface is approximately 10 degrees.

8. The system of claim 1, wherein said fluid jet comprises two or more nozzles.

9. A system for directing a fluid in a rotating machine comprising:
a shaft defining an axis of the machine;
a fluid catching member positioned radially outward of said shaft, said fluid catching member having:
a surface extending radially outward from said shaft; and
a flange extending axially along a portion of said shaft and away from said surface, said flange bounding in part a fluid catchment volume between said flange and a portion of said shaft; and
a fluid jet positioned radially outward of said fluid catching member flange, said fluid jet being configured to eject a stream of fluid under pressure such that the stream of fluid has an angle of incidence of less than 30 degrees with said surface of said fluid catching member at a first point where the stream contacts said surface.

10. The system of claim 9, wherein said angle of incidence is less than 15 degrees.

11. The system of claim 10, wherein said angle of incidence is approximately 10 degrees.

12. The system of claim 9, wherein said fluid jet is further configured to eject said stream of fluid in a direction of rotation of said shaft.

13. The system of claim 9, wherein said surface of said fluid catching member defines one or more fluid supply orifices configured to supply oil in an axial direction.

14. The system of claim 9, wherein said fluid catching member comprises a retention member extending radially inward from said flange of said fluid catching member at a forward axial end of said flange.

15. The system of claim 14, wherein said fluid catching member comprises an annular groove defied by said surface, flange, and retention member of said fluid catching member.

16. The system of claim 15, wherein said fluid jet is configured to eject a stream of fluid into said annular groove.

17. A method of supplying a fluid in a rotating machine comprising a shaft defining an axis, a fluid catching member affixed to and having a surface extending radially outward from said shaft, and a fluid jet located radially outward from said fluid catching member, said method comprising:
ejecting a stream of fluid from said fluid jet in a direction substantially parallel to said surface of said fluid catching member.

18. The method of claim 17, further comprising:
impinging said shaft with said stream prior to said stream contacting said surface.

19. The method of claim 17, wherein the ejecting said stream causes the stream to impact said surface at low angle of incidence of approximately 10 degrees at a first point where the stream contacts said surface.

20. The method of claim 17, wherein the ejecting said stream causes a portion of said stream to impinge said shaft at an angle less than 45 degrees.
